(19) United States
(12) Patent Application Publication
(10) Pub. No.: US 2018/0098679 A1
(43) Pub. Date: Apr. 12, 2018

(54) SPONGE FOR CLEANING DISH SURFACES AND METHOD OF MANUFACTURE

(71) Applicant: The Procter & Gamble Company, Cincinnati, OH (US)

(72) Inventor: Denis Alfred GONZALES, Brussels (BE)

(21) Appl. No.: 15/727,111

(22) Filed: Oct. 6, 2017

Related U.S. Application Data
(60) Provisional application No. 62/404,869, filed on Oct. 6, 2016.

(51) Int. Cl. A47L 13/16; C08J 9/12

(52) U.S. Cl. CPC A47L 13/16; C08J 9/122

(57) ABSTRACT

A sponge for cleaning dish surfaces comprising a foam and abrasive particles disposed within the foam in an amount of from about 0.1% to about 30% by weight of the sponge. Further, methods of manufacturing the sponge for cleaning dish surfaces. Further, method of cleaning a dish surface using the sponge.

### FIELD OF THE INVENTION

The present invention relates to the field of sponges for cleaning dish surfaces with hand dishwashing compositions, in particular liquid hand dishwashing compositions. More specifically, the present invention relates to a sponge comprising a foam and abrasive particles disposed within the foam, a method of manufacturing the sponge, and a method of cleaning a dish surface with the sponge.

### BACKGROUND OF THE INVENTION

Sponges made from synthetic foam for use with hand dishwashing compositions for washing dishes, pots and pans (“dishware”) are known in the art. Composite cleaning sponges have been developed to remove food deposits which adhere to the dishware. For example, the composite cleaning sponge may comprise a foam layer and a layer of fibers made from natural or synthetic fibers (also known as a scouring pad) affixed to the foam layer typically by an adhesive. The scouring pad is known to be effective in removing caked-on soil such as food from dish surfaces but it is often too abrasive and may cause damage to the dish surfaces such as a non-stick coating such as a Teflon™ coating on a frying pan. Further, food, dirt or the debris are often trapped within the scouring pad and cause bacteria to breed within the sponge. Additionally, the scouring pad is not as porous as the foam layer in the sponge, and forms an additional barrier for absorption of water or liquid hand dishwashing compositions by the sponge.

A cleaning sponge comprising a sponge body with embedded fiber clusters for limiting food from being trapped within the sponge is described in International Patent Publication Number WO2010/118320 (“WO2010/118320”). In WO2010/118320, each fiber cluster comprises a web of fibers with openings through which material of the sponge body penetrates during formation of the sponge, thus anchoring the fiber clusters in place. Coating a sponge with abrasive particles such as powder activated carbon is described in International Patent Publication Number WO201156632. However, the difficulties in achieving an efficient abrasive cleaning action in a sponge with minimal damage to surfaces remain. Accordingly, there is a need for a sponge that makes cleaning easier with minimal damage to surfaces.

### SUMMARY OF THE INVENTION

The present invention relates to a sponge for cleaning dish surfaces, the sponge comprising:
a foam selected from the group consisting of: polyurethane foam, cellulose foam, polyvinyl alcohol (PVA) foam; and
abrasive particles disposed within the foam in an amount of from about 0.1% to about 30%, preferably from about 0.5% to about 20%, more preferably from about 1% to about 10%, most preferably from about 1% to about 5% by weight of the sponge, wherein the abrasive particles are solid and comprise a mean solidity from about 0.4 to about 0.75, preferably from about 0.5 to about 0.7, and more preferably from about 0.55 to about 0.65.

Solidity is a mesoshape parameter, which describes the overall concavity of a particle or particle population. An effect of the claimed range of mean solidity of the abrasive particles is it provides the desired sharp edges and abrasiveness to a sponge for cleaning. In particular, incorporating abrasive particles of the specified solidity into the foam results in a sponge having a modified foam cellular structure with sharp edges. The sharp edges result in improved abrasive cleaning properties of the sponge relative to a sponge without particles and/or a sponge with particles without a defined solidity.

A cleaning mechanism of abrasive particles having a particle shape as defined by the claimed solidity is through sliding of the abrasive particles to displace soil from a surface. In contrast, spherical abrasive particles (i.e. having a solidity of 1) promote rolling movement which is less effective in displacing soil from the surface. An advantage of incorporating the abrasive particles having the specified mean solidity into the foam is that the particles may be mechanically retained in position within the foam and maintained in a specific orientation relative to the foam and therefore relative to the surface being cleaned, during scouring. Also, preventing “rolling” of the particles relative to the foam may generate less damage to the surface to be cleaned.

The present invention also relates to a method of manufacturing a sponge for cleaning dish surfaces, the method comprising:
mixing abrasive particles in a foaming resin in an amount from about 0.1% to about 30%, preferably from about 0.5% to about 20%, more preferably from about 1% to about 10%, most preferably from about 1% to about 5% by the total weight of the foaming resin and the abrasive particles at a temperature of between about 10° C. and about 150° C. degrees C. for a time period of between about 0.5 minutes and about 60 minutes;
allowing the foaming resin comprising the abrasive particles to rise to form a sponge comprising a foam selected from the group consisting of: polyurethane foam, cellulose foam, polyvinyl alcohol (PVA) foam; and
curing the foam for a time period of between about 0.5 and about 48 hours at a temperature between about 10° C. and about 50° C. to form the sponge; wherein the abrasive particles are solid and comprise a mean solidity from about a mean solidity from about 0.4 to about 0.75, preferably from about 0.5 to about 0.7, and more preferably from about 0.55 to about 0.65.

An advantage of the above method is that a sponge can be produced during a single process of co-foaming of a foam resin and abrasive particles, i.e. in-situ foaming. Having the particles in an amount of less than or equal to 30% by weight of the sponge enables the foam to be stable and formed with air bubbles. As the sponge has improved abrasive properties by incorporating the properties of the abrasive particles within its foam cellular structure, there is no longer a need for attaching additional piece of scouring pad thereby improving manufacturability of the sponge.

### BRIEF DESCRIPTION OF THE DRAWINGS

FIG. 1 is a schematic perspective view of a sponge according to the present invention;

FIG. 1A is a partial schematic cross section of the sponge of FIG. 1;

FIG. 2 is a schematic section view of an exemplary abrasive particle for a sponge according to the present invention;

FIG. 2A is a partial enlarged schematic section view of the exemplary abrasive particle for a sponge of FIG. 2;

FIG. 3 is a schematic view of an exemplary abrasive particle for a sponge according to the present invention;

FIGS. 4A-4E are drawings showing illustrations of exemplary abrasive particles for a sponge according to the present invention and the respective parameters;

FIG. 5 is a schematic view of a convex hull area and an area of exemplary abrasive particles;

FIG. 6 is a schematic perspective view of an exemplary abrasive particle for a sponge according to the present invention;

FIG. 7A is a photograph of an exemplary abrasive particle made from polyurethane foam;

FIG. 7B is a photograph of the polyurethane foam used for making an exemplary abrasive particle;

FIG. 8A is a photograph of exemplary abrasive particles made from mineral foam (cured kaolin);

FIG. 8B is a photograph of an exemplary abrasive particle made from polylactic;

FIG. 8C is a photograph of an exemplary abrasive particle made from polyhydroxybutyrate-co-valerate (PHBV); and

FIG. 9 is a schematic perspective view of an exemplary composite sponge according to the present invention.

### DETAILED DESCRIPTION OF THE INVENTION

All percentages, ratios and proportions used herein are by weight percent unless otherwise specified.

As used herein “circularity” refers to a quantitative, 2-dimension image analysis shape description and is being measured according to ISO 9276-6:2008(E) section 8.2 as implemented via the Occhio Nano 500 Particle Characterisation Instrument with its accompanying software Callistro version 25 (Occhio s.a. Liege, Belgium). Circularity is a preferred mesoshape descriptor and is widely available in shape analysis instrument such as in Occhio Nano 500 or in Malvern Morphologi G3. Circularity is sometimes described in literature as being the difference between a particle's shape and a perfect sphere. Circularity values range from 0 to 1, where a circularity of 1 describes a perfectly spherical particles or disc particle as measured in a two dimensional image.

$$C = \sqrt{\frac{4 π A}{{P}^{2}}}$$

Where A is projection area, which is 2D descriptor and P is the length of the perimeter of the particle.

As used herein “dish surfaces” refers to any kind of surfaces found in dish cleaning, such as dishes, cutlery, cutting boards, pans, and the like. Such dish surfaces may be found both in private households as well as in commercial, institutional and industrial environments.

As used herein “liquid detergent composition” refers to those compositions that are employed in a variety of cleaning uses including dishes, household hard surfaces (e.g., floors, countertops etc) and the like. A preferred liquid detergent composition for use with an abrasive sponge of the present invention is a “liquid dish detergent composition,” which refers to those compositions that are employed in manual (i.e. hand) dish washing. Such compositions are generally high sudsing or foaming in nature.

As used herein “mean Equivalent Circle Diameter (ECD)” refers to a size measurement of abrasive particles measured according to ASTM F1877-05 Section 11.3.2 or similar to the area-equivalent diameter (ISO 9276-6:2008(E) section 7). The mean ECD of particle population is calculated as the volume-weighted average of respective ECD of a particle population of at least about 1000 particles, or at least about 10,000 particles, or above about 50,000 particles, or above about 100,000 particles after excluding from the measurement and calculation the data of particles having area-equivalent diameter (ECD) of below about 10 micrometers.

As used herein with regard to abrasive particles made by extruding, the ECD refers to the diameter of similar area-equivalent circle of a cross-section of the extruded fibers used to create the abrasive particles after slicing the fibers.

As used herein “Shore® D hardness” refers to hardness of a material determined according to ASTM D2240-05 (2010). Shore® D hardness measurement may be carried out by using an ASTM durometer, such as the Type D Style Durometer available from Pacific Transducer Corp. of Los Angeles, Calif., or from ELECTROMATIC Equipment Co., Inc. 600 Oakland Ave Cedarhurst, N.Y. 11516.

As used herein, the term “solidity” refers to a mesoshape parameter which describes the overall concavity of a particle. For purposes of this disclosure, solidity is represented by the equation: Solidity=A/Ac, and is measured according to ISO 9276-6:2008(E) section 8.2 as implemented via the Occhio Nano 500 Particle Characterisation Instrument with its accompanying software Callistro version 25 (Occhio s.a. Liege, Belgium). Where the abrasive particle is produced by grinding, “A” is the area of the abrasive particle and “Ac” is the area of the convex hull (envelope) (hereinafter “convex hull area”) bounding the particle. Where the abrasive particle is created by extrusion, “A” is the area of a cross-section of the abrasive particle perpendicular to the extrusion axis of extruded fibers and “Ac” is the convex hull area of the cross-section of the abrasive particle perpendicular to the extrusion axis. During the particle shape analysis, the particles are oriented toward a measurement surface via gravity deposition which is similar to the expected particle orientation towards a surface to be cleaned during use.

Solidity values range from 0 to 1, where a solidity number of 1 describes a shape with no concave portions (when measured according to the method set forth herein). Applicants have found that the solidity of particles measured in accordance with the method set forth herein correlates with the self-attachment characteristics of the particles and to their cleaning performance Without wishing to be bound by theory, it is believed that the correlation is at least partially due to the orientation of the particles toward a surface to be cleaned during use. More specifically, Applicants have found that a volume-weighted mean solidity extracted from a distribution of particle measurements is a good indicator of the cleaning efficacy of a product including a plurality of particles. As used herein “mean solidity” refers to the volume-weighted average of the solidity from a population of at least about 1000 particles (unless a different number is specifically set forth) after excluding from the measurement and calculation, the solidity data of particles having area-equivalent diameter (ECD) of below 10 micrometers. Of course, because the mean solidity is measured on a population of at least about 1000 particles, it can be measured on any number of particles over that minimum, including but not limited to at least about 10,000 particles, at least about 50,000 particles, or at least about 100,000 particles.

As used herein “Vickers hardness HV” refers to a hardness of a material measured at 23° C. according to standard methods ISO 14577-1, ISO 14577-2, ISO 14577-3. The Vickers hardness is measured from a solid block of the raw material at least 2 mm in thickness. The Vickers hardness micro indentation measurement is carried out by using the Micro-Hardness Tester (MHT), manufactured by CSM Instruments SA, Peseux, Switzerland. As per the ISO 14577 instructions, the test surface should be flat and smooth, having a roughness (Ra) value less than 5% of the maximum indenter penetration depth. For a 200 micrometer maximum depth this equates to a Ra value less than 10 micrometer. As per ISO 14577, such a surface may be prepared by any suitable means, which may include cutting the block of test material with a new sharp microtome or scalpel blade, grinding, polishing or by casting melted material onto a flat, smooth casting form and allowing it to thoroughly solidify prior testing.

Suitable general settings for the Micro-Hardness Tester (MHT) are as follows:
Control mode: Displacement, Continuous
Maximum displacement: 200 μm Approach speed: 20 nm/s
Zero point determination: at contact
Hold period to measure thermal drift at contact: 60 s
Force application time: 30 s
Frequency of data logging: at least every second
Hold time at maximum force: 30 s
Force removal time: 30 s
Shape/Material of intender tip: Vickers Pyramid Shape/Diamond Tip

### Sponge Comprising Abrasive Particles

The present invention relates to a sponge comprising improved abrasive properties for removal of soil from dish surfaces without the drawbacks of a scouring pad, while having substantially equivalent physical properties of a conventional soft sponge such as water absorption and/or release rates, foamability, rinsability, durability and flexibility for adapting to contours of surfaces for cleaning. For example, the sponge is deformable so as to conform to surfaces of the dishware and is porous to provide a water-holding capacity so that water or soap solution may be continuously supplied to a soiled surface of the dishware.

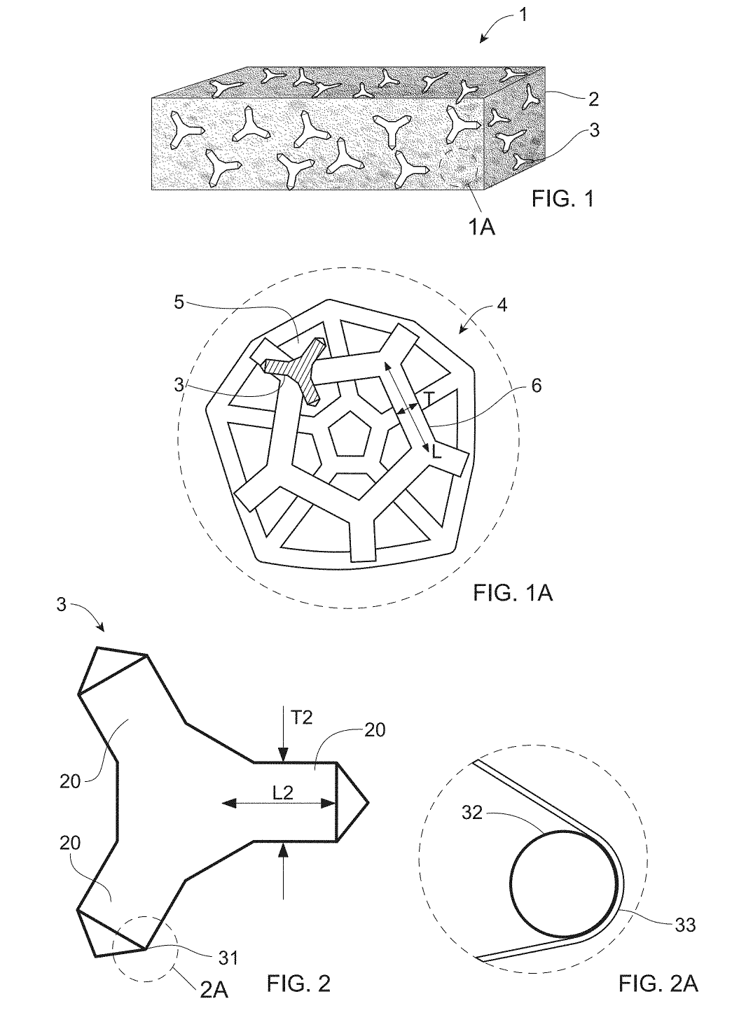

FIG. 1 is a schematic drawing of a sponge 1 according to the present invention. The sponge 1 comprises a foam 2 (hereinafter “foam”) with abrasive particles 3 disposed within the foam 2. FIG. 1A is a partial schematic cross section view of the foam 2 comprising a cellular structure 4 with an abrasive particle 3 located within the cellular structure 4.

The abrasive particles 3 are provided within the foam 2 in an amount of from about 0.1% to about 30%, preferably from about 0.5% to about 20%, more preferably from about 1% to about 10%, most preferably from about 1% to about 5% by weight of the sponge 1 for stability of the foam 2. This amount prevents foam collapse or collapse of foam pores during formation of the foam 2.

Further, the abrasive particles 3 are solid and comprise a specified solidity for physical attachment to, and orientation within the cellular structure 4, as well as providing good cleaning properties while having a relatively low hardness to dish surfaces for removal of soil without or with minimum surface damage. In particular, the abrasive particles 3 may comprise a mean solidity from about 0.4, 0.5, or 0.55 to about 0.65, 0.7, or 0.75. Alternatively, a mean solidity of the abrasive particles 3 may be from about 0.4 to 0.75, preferably 0.5 to 0.7, more preferably 0.55 to 0.65. The specific particle shape as defined by the claimed solidity may promote effective sliding of the abrasive particles compared to spherical abrasive particles, where rolling movement is rather promoted and which are less effective in displacing soil from the surface. An advantage of incorporating the abrasive particles 3 having the specified mean solidity into the foam 2 is that the particles may be mechanically retained or embedded in position within the foam and maintained in a specific orientation relative to the foam and therefore relative to the surface being cleaned, during scouring. Also, preventing “rolling” of the particles relative to the foam may generate less damage to the surface to be cleaned. Another advantage is the durability of the particles during consumer use and manufacturing. For example, if the solidity is too low, i.e. 0.1, the particle may break easily either during manufacture of the particles or the sponge or during cleaning, and result in poor abrasive cleaning, and undesired debris deposited on surfaces during cleaning. If the solidity is 1, the particle will not have effective cleaning because it is shaped like a sphere which results in rolling action which is less effective for cleaning.

Preferably, the abrasive particles 3 comprise a circularity of the abrasive particles is from about 0.1 to 0.6, preferably from about 0.2 to 0.5, and more preferably from about 0.25 to 0.45. Advantageously, the circularity provides sufficient roughness and scrapping edges for effective cleaning and the particles are also securely anchored to the foam 2.

Exemplary abrasive particles which can be co-foamed with foam raw materials and which comprise the abovementioned geometric parameters to promote effective sliding are described with respect to FIGS. 2 to 5.

FIG. 2 is a schematic section view of an exemplary abrasive particle 3 for a sponge 1 according to the present invention. The abrasive particle 3 comprises struts 20 with an aspect ratio from about 1.5 to 10, wherein the aspect ratio is expressed by a ratio between a strut length (L2) and a strut thickness (T2) at mid length. Specifically, the applicant has found that a good cleaning effect can be achieved with abrasive particles which have been made from the foams featuring struts with high aspect ratios. The struts 20 are similar in structure to the elongated material that interconnects to form the cellular structure of the foam. This enables the particles 3 to fit and form at least part of the foam and therefore the abrasive particles are less prone to being dislodged during cleaning. As the particles form part of the foam struts and do not obstruct the pores, a pore size of pores of the foam are substantially the same as pore size of conventional foam without particles and therefore the sponge also retains physical flexibility, water and/or liquid detergent composition absorption, and release properties of conventional sponges.

The applicant has understood that particles comprising struts with excessively small L2/T2 ratio present sub-optimal shapes for cleaning since likely to produce rounder particles that readily roll. On the contrary, the particles comprising struts with excessively high L2/T2 ratio also present sub-optimal shape for cleaning since they are likely to produce excessive amount of rod-like particles featuring low soil removal. Incidentally, the applicant has surprisingly found that significantly better cleaning effect can be achieved with struts having an L2/T2 ratio ranging from 1.5 to 10, preferably from 2.0 to 8.0 and more preferably from 3.0 to 6.0 and most preferred from 3.5 to 4.5 as defined by Visiocell software.

FIG. 2A is a partial enlarged schematic section view of the exemplary abrasive particle for a sponge of FIG. 2. Referring to FIG. 2A, the abrasive particle 3 comprises a plurality of sharp edges 31 which having a diameter edge tip radius (DETR) below 20 μm, preferably below 8 μm, most preferably from 5 μm to 0.5 μm. The tip radius is defined by the diameter of an imaginary circle 32 fitting the curvature of the edge extremity 33, as exemplified in FIG. 2A.

The above particle shape properties may also be achieved by abrasive particles of a different geometry obtained by extrusion wherein each of the abrasive particles comprise extruded protrusions having a longitudinal length (L) extending parallel to a z-axis and defining a cross-section of the abrasive particle. The advantage of extruded protrusions is the cross-section is very monodispersed. Dispersity is a measure of the heterogeneity of sizes of molecules or particles in a mixture. A monodispersed, or uniform polymer is composed of molecules of the same mass. One the other hand, for particles which are grinded from foam, the shape/size of the particles are not uniform since the foam structure and the grinding operation make the particle population non-uniform in size/shape. Extruded fibers are formed by material going through an extrusion die having a hole, through a slurry) which result in fiber shaped extruded material (“extruded fibers”). The extruded fibers comprise extruded protrusions having a longitudinal length (L) extending parallel to the extrusion axis of the fibers and defining a cross-section of the abrasive particle perpendicular to the extrusion axis.

Preferably, the cross-section of the abrasive particle may comprise a mean solidity from about 0.4 to about 0.75, preferably from about 0.5 to about 0.7, and more preferably from about 0.55 to about 0.65, and wherein the ratio of said length (L) to an ECD of the cross section of the abrasive particle is from about 0.5 to about 3, preferably from about 1 to about 2.5, more preferably from about 1.5 to about 2. Tables 4A to 4E show exemplary abrasive particles made from extrusion of different thermoplastic or elastomeric material which has various configurations of the solidity and ratio (L/ECD). The advantage is good balance of physical properties of the particles for anchorage and to deliver the cleaning performance when the cross-section of the particle is produced from extruded fiber which corresponds to the cross-section of the fibers (prior to slicing).

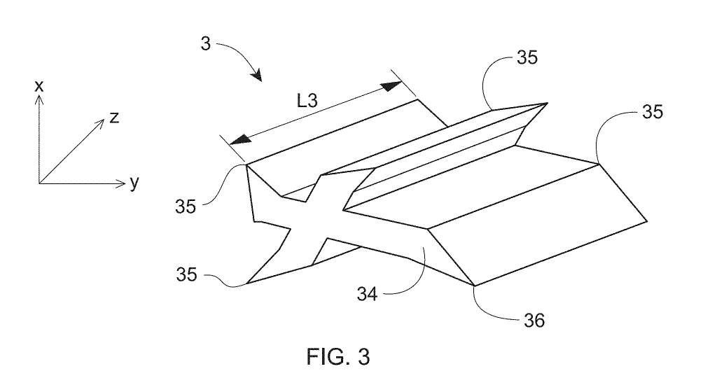

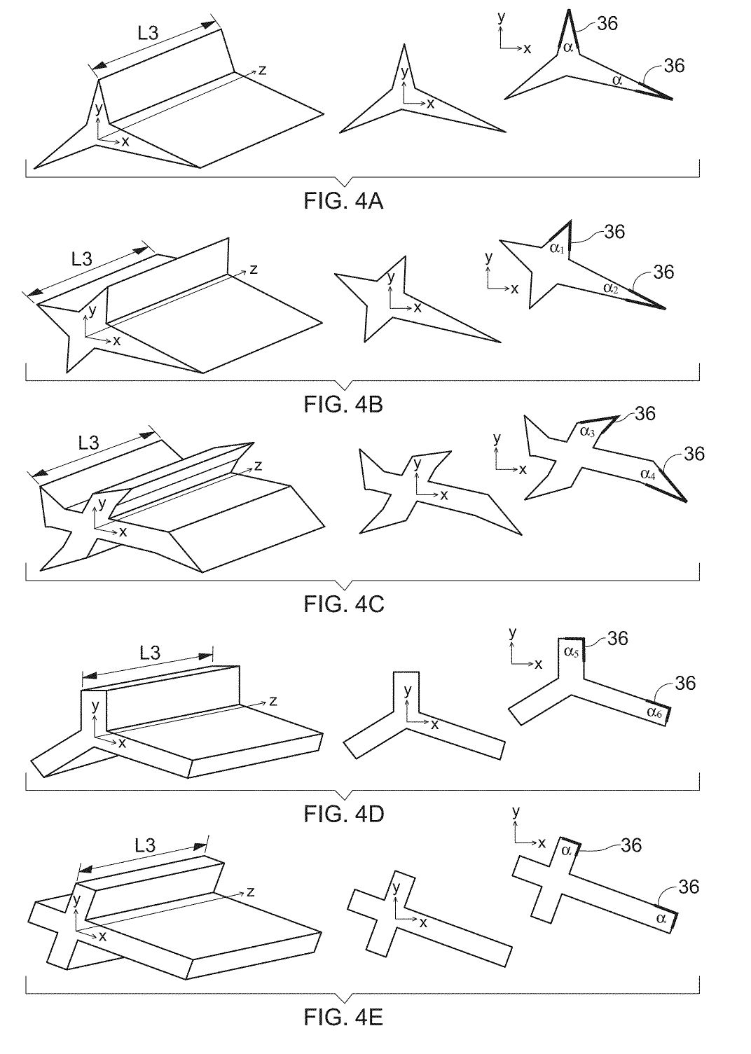

FIG. 3 is a schematic view of an exemplary abrasive particle 3 for a sponge 1 according to the present invention. FIGS. 4A-4E are drawings showing illustrations of exemplary abrasive particles 3 for a sponge according to the present invention and the respective parameters.

The abrasive particle 3 may comprise a longitudinal length “L3” extending parallel to a z-axis and a cross-section 34 extending on a plane perpendicular to said longitudinal length “L3” and parallel to an x-y plane. The abrasive particle 3 comprises one or more elongate protrusions 35 defining the cross-section 34, each protrusion 35 having at least one edge 36. The abrasive particle 3 may be extruded as it has the benefit of lower production cost and faster particle production turnaround.

The protrusions 35 may extend along substantially the entire length “L3”. This has the advantage of maximizing the scraping surface or scraping edge during scrubbing, thus increasing the amount of soil being lifted from a given surface at any given cleaning stroke.

The selection of the longitudinal length “L3” is done such that there is a large number of particles lying on the surface to be cleaned whereas the particle longitudinal length “L3” is parallel to the plan of the surface to be cleaned and L3 is substantially perpendicular to the cleaning direction therefore yielding for a maximum cleaning efficiency

If L3 is too short, a large number of particles will orientate on the surface to clean whereas the XY cross-sectional plan of the particles is parallel to the plan of the surface to be cleaned and the cleaning efficiency is suboptimal independently from the cleaning direction.

If L3 is too long, a large number of particles will orientate on the surface to clean whereas L3 is parallel to the plan of the surface to be cleaned and L3 is substantially parallel to the cleaning direction therefore yielding equally suboptimal cleaning efficiency.

The longitudinal length “L3” may be dimensioned such that said protrusions 35 when placed onto a surface and a cleaning force is applied in a cleaning direction spontaneously orientate themselves to deliver optimal cleaning efficiency, and wherein at least 50%, preferably at least 60%, more preferably at least 65%, even more preferably at least 70%, most preferably at least 80%, of the protrusions 35 align accordingly to an orientation angle such that the length “L3” is substantially perpendicular to said cleaning direction and at least a portion, preferably all, of length “L3” is parallel to said surface, as measured according to the method herein. This has the advantage that at any given cleaning stroke the particles scrape the maximum soil surface.

The geometry of the XY cross-sectional plane of the particles 3 is dimensioned such as the particles are substantially not rolling around their Z-axe during the cleaning motion. Incidentally the cross-section of the particle is substantially irregular, preferably featuring elongated protrusions such as to increase the aspect ratio of the cross-section that minimize from partially to significantly the occurrence of the rolling phenomenon around the Z-axe of the particle. Cross-section geometries featuring at least one or two elongated protrusions are found effective whereas the extension of the elongation further reinforce the ability of the particle to avoid rolling toward the cleaning direction during the cleaning event.

The particle described here above is tailored to slide across the surface to be cleaned in an optimal motion fashion to deliver the optimal cleaning. However, the presence of at least one scrapping edge, preferably several scrapping edges along the Z-axe at the periphery of the particle cross-section, preferably with substantial sharpness as defined by a low tip radius, further optimizes the cleaning performance of the particle.

The protrusions 35 may be symmetrical about a plane perpendicular to said longitudinal length “L3” and are preferably symmetrical or asymmetrical about a plane parallel to said longitudinal length “L3”. Such arrangement ensures that continuous scraping edges are formed along length “L3” whilst having a very intricate cross-section to promote non-rolling around the Z-axis and optimal abrasion through the soil/surface interface.

FIGS. 4A-4E are drawings showing illustrations of exemplary abrasive particles for a sponge according to the present invention and the respective parameters. For example, the abrasive particle 3 may comprise more than two elongate protrusions 35, preferably in the form of abrasive wings preferably having a shape selected from the group consisting of substantially linear, substantially concave, substantially convex and combinations thereof. An advantage is the protrusions 35 can effectively scoop the soil from a surface. Alternatively, the abrasive particle 3 may comprise from 3 to 30, preferably from 3 to 24, preferably from 3 to less than 20, more preferably from 3 to less than 15, even more preferably from 3 to less than 6, even more preferably from 3 to 4, most preferably 3, of said protrusions 35. An advantage is that resistance to rolling is further increased such that scraping is promoted.

The edge 36 (or scraping edge) may comprise an angle α, α₁, α₂, α₃, α₄, α₅ or α₆ of from 10° to 90°, preferably from 20° to 80°, more preferably from 30° to 60°, even more preferably from 40° to 60°. Such sharp edges ensure improved scraping of soil.

In a preferred embodiment more than 70%, preferably more than 80%, more preferably at least 90%, of the particle population exhibit the same shape of the cross-section and more than 70%, preferably more than 80%, more preferably at least 90%, of the particle population exhibit the same length. Both cross-section shape and length ensure optimal cleaning and surface safety performance.

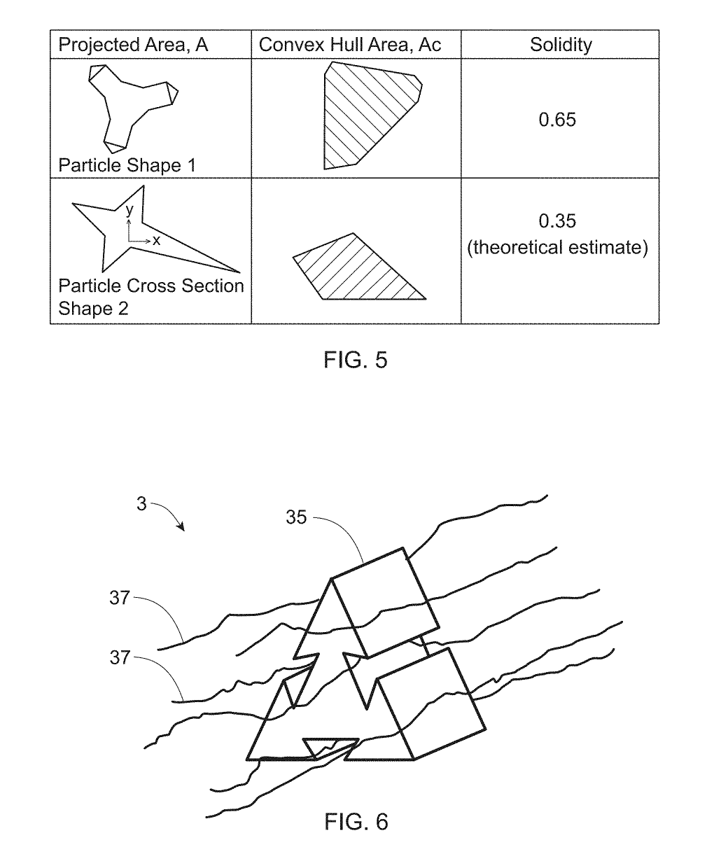

FIG. 5 is a schematic view of a convex hull area Ac and an area A of exemplary abrasive particles wherein the convex hull of a particle may be regarded as the particle surrounded by a convex envelope and is used to define the convex hull area, A_{c}.

As described earlier, solidity is defined as A/A_{c}, therefore as the particle becomes more solid, i.e. having less concave surfaces, the area A and convex hull area A_{c} approach to each other and the solidity would be greater than another particle which has more concave surfaces (less solid). For example, referring to FIG. 5, Particle Shape 1 has less concave surfaces than Particle Shape 2 and has a higher solidity value relative to Particle Shape 2.

FIG. 6 show an exemplary abrasive particle 3 comprising protrusions 35 and one or more fibers 37, preferably a single continuous fiber of a material selected from organic or inorganic typically in the form of slurry based on water or solvent comprising solution, most preferably said material being a thermoplastic or thermocurable or mineral material or blend of thermoplastic and/or thermocurable and/or mineral material. The advantage of having more fibers per protrusion 35 is that more intricate cross-sectional shapes may be formed to increase the surface area of contact upon scrubbing onto a surface.

Preferred abrasive particles suitable for use herein are hard enough to provide good cleaning performance and minimizing damage to the surfaces for cleaning. In particular, by incorporating the abrasive particles of a relatively lower hardness than a scouring pad, the sponge provides efficient abrasive cleaning while minimizing damage to dish surfaces.

Preferably, the abrasive particles have a mean Shore® D hardness of between about 40, 45, 50, 55, or 60 and about 65, 70, 75, 80, 85 or 90. The advantage is to achieve an optimal balance between cleaning the soil from the surface without damaging or minimizing damage to the surface. Specifically, soils typically found on dishes generally have a Shore® hardness below 40 and dish surfaces may comprise a Shore® D hardness of typically greater than 90. Therefore, the abrasive particles having a Shore® D hardness less than a Shore® D hardness of dish surfaces can effectively remove the soil without scratching the dish surfaces. The abrasive particles may also comprise HV Vickers hardness from about 5 kg/mm² to about 100 kg/mm². preferably from 10 to 50 kg/mm² and most preferably from 15 to 35 kg/mm². It will be appreciated by the skilled person that Shore® D hardness is easier to measure in that it requires a shorter time and is of a lower precision but the range of hardness is lower. On the other hand, Vickers hardness HV is harder to measure in that it requires a longer time and is of a higher precision, but its range of hardness is larger. Therefore when determine hardness of a material such as the hardness of the abrasive particles, both methods may be used but Shore® D hardness may be used when measurements are needed quickly.

Incorporation of the abrasive particles may in particular increase hardness of the sponge relative to a sponge without abrasive particles without influencing flexibility of the foam forming the sponge. Such advantageous effect cannot be achieved when simply coating a surface of the foam with abrasive particles as the coated abrasive particles form a harder layer than the foam which will affect the flexibility of the foam.

The hardness of the abrasive particles reduced from the foam can be modified by changing the raw material used to prepare the foam. For example modification of the hardness of the polyurethane foam is possible via several ways. For example, without being exhaustive, the selection of the diisocyanate and especially the selection of the isocyanate with high functionality e.g.: >2, preferably >2.5, most preferably above 2.7, increases the polyurethane hardness wherein functionality is the presence of functional groups in a molecule. Similarly, the use of low molecular weight polyols e.g.: <4000 Mw, preferably <2000 Mw and most preferably below 1000 Mw also increase the polyurethane hardness. More importantly is the balance diisocyanate/polyols in the reaction mixture, although excess of diisocyanate also increase the foam hardness. Another possibility to increase hardness is to introduce a small molecular weight crosslinker. Alternatively selection of catalyst, will promote the formation of urea bond, is additional way to increase the foam hardness.

Specifically, a material of the foam 2 comprises polyurethane foam, cellulose foam, polyvinyl alcohol (PVA) foam or mixtures thereof. The advantage of using the abovementioned material for the foam 2 in a sponge 1 for dishwashing applications as the foam comprises open, interconnected pores that permit the passage of air, water, and liquid detergent composition when the foam 2 is not compressed. The sponge 1 comprises a density greater than 20 kg/m³ to prevent liquid run through, hence securing liquid absorbing power and to provide durability during use. Specifically, the sponge 1 may be less susceptible to tearing during use and/or manufacturing. Referring to FIG. 1A, the foam 2 comprises foam pores 5 for absorbing and releasing liquid such as water and liquid detergent compositions such as hand dishwashing compositions. Preferably, the cellular structure 4 is a pentagonal dodecahedron structure for foams with a density typically between 5 and 50 kg/m3. The cellular structure 4 comprises open, interconnected foam pores 5 and struts 6 circumscribing the pores 5. The struts 6 refer to the elongated material that interconnects to form the cellular structure 4 of the foam 2. Each strut 6 comprises a strut length (L) and a strut thickness (T) whereby the strut length (L) is typically counted as the distance between geometrical centers of two interconnecting knots and the strut thickness (T) is typically the projected strut thickness at the middle of the strut length (L).

Preferably, each of the abrasive particles 3 is of a size sufficient to be securely within the cellular structure 4 of the foam 2 so that the particles 3 are less prone to being dislodged during cleaning while providing improved abrasive cleaning properties in the sponge 1.

Preferably, the foam 2 comprises a pore size from about 200 μm to about 5000 μm, preferably from about 300 μm to about 2000 μm, more preferably from about 400 μm to about 1000 μm and the abrasive particles comprise a mean Equivalent Circle Diameter (ECD) from about 10 μm to about 1000 μm, preferably from about 20 μm to about 600 μm, more preferably from about 100 μm to about 600 μm, most preferably from about 200 μm to about 400 μm. The pore size of the cellular structure also correlates to a foam porosity which defines absorbing and releasing properties, rinsability and inherent sudsing properties of the foam 2. Having any one of the above combinations of the foam pore size and abrasive particle size enables the particles 3 to be physically anchored to the foam 2 while leaving sufficient free surface space of the particles 3 to enable demonstration of their abrasive power during cleaning and maintaining the abovementioned of the foam 2. The pore size of the foam may be measured by a microscope or Visiocell software according to methods known by the skilled person.

Matching foam cell size with particle size is important to enable the particles to connect to the sponge as too large foam cell sizes would not allow first, particle edges to connect to the sponge and second, sufficient free surface space of the particles to enable demonstrating their abrasive power. Alternatively, if the foam cell size is too small, the particles will coat the sponge, and then abrasive edges are not available anymore for an effective cleaning action.

Specifically, if the foam pore size is larger such as greater than 5000 μm, the particle edges may not be oriented properly within the foam for cleaning and if the foam size is too small such as less than 200 μm, the particles 3 will coat the foam surface and the edges of the abrasive particles will not protrude out of the foam pores and be available for cleaning. Preferably, referring to FIG. 1A, at least a portion of the particle 3 may be protruding outside of the cellular structure 4, i.e. into the foam pores 5 of the foam 2 for effective scrapping of the soil from dish surfaces but the size is small enough so that the protruding parts of the particles do not to block the foam pores 5 and therefore a capillary action or migration of liquid or solid through the foam pores 5 are not obstructed and the sponge can enable sudsing when wetted with liquid detergent composition and water.

Preferably, the abrasive particles are solid and comprise a material selected from the group consisting of: polyethylene, polypropylene, PVC, polycarbonate, melamine, urea, polyurethane, polyacrylate, polystyrene, phenolic, polyesters, polyamide, cellulosic polymers, polyhydroxyalkanoate, polylactic, polybutylenesuccinate, polycaprolactone, minerals and mixtures thereof. Specifically, the abovementioned material of the abrasive particles comprise reactive functional groups which are highly reactive with functional groups of components suitable for making the foam so the particles 3 will be bound chemically to the foam 2 and form at least part of the foam cell structure and/or walls. As a result, the abrasive particles 3 are less prone to being dislodged during cleaning while improving the overall abrasive properties of the sponge 1.

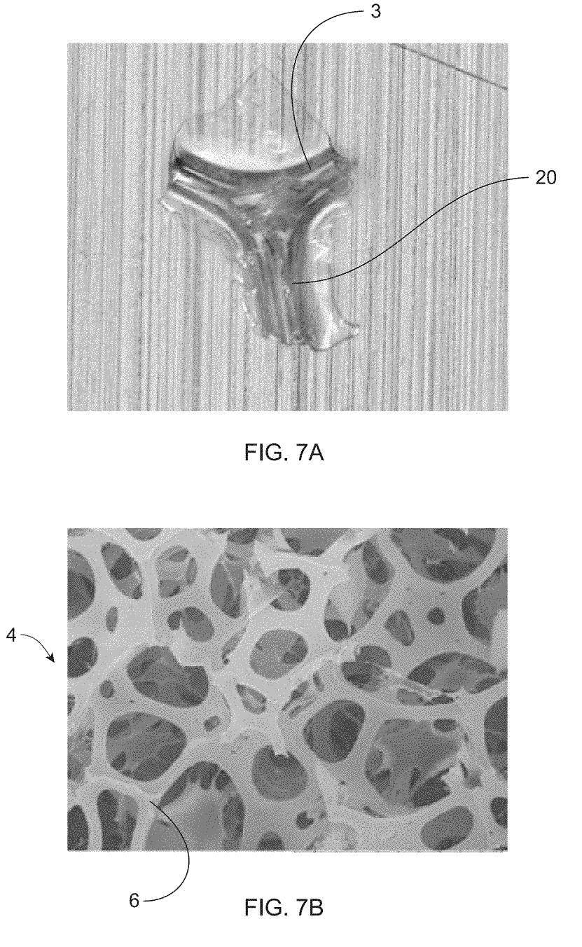

Preferably, wherein a material of the abrasive particles are made from a foamed polyurethane material comprising a density from about 25 kg/m³ to about 120 kg/m³ as measured, for instance, using the protocol described in ASTM D3574, and a compressive strength greater than or equal to 80 kPa (0.8 kg/cm²) up to 300 kPa (3 kg/cm²) with 10% deformation measured according to EN 826. Alternatively, the foamed polyurethane material comprises a density from about 33 kg/m³ to about 80 kg/m³, more preferably from about 33 kg/m³ to about 60 kg/m³. Alternatively, the density of the foamed polyurethane material may be from about 42 kg/m³ to about 50 kg/m³. The advantage of particles made from the above foam material is the foam properties enable an easier way of controlling the desired shape of the particles as defined by solidity and circularity. Specifically, the above foam properties provide an ideal aspect ratio of the foam struts for obtaining the solidity and/or circularity values as described herein. As a result, a desired shape of the abrasive particles may be manufactured easily and in an efficient manner FIG. 7A is a photograph of an exemplary abrasive particle 3 made from a foamed polyurethane material and FIG. 7B is a photograph of a cellular structure 4 of the foamed polyurethane material. It will be appreciated that the exemplary abrasive particle 3 comprises foam struts 22 corresponding to foam struts 6 of the cellular structure 4 of the foamed polyurethane material from which the abrasive particle 3 is derived.

Preferably, the density of the polyurethane foam is about 30 to about 60 kg/m3. It will be appreciated by the skilled person that the density affects the shape of the abrasive particles as well as influences the porosity and overall foam cell structure. This enables an optimal particle solidity and/or circularity and/or size to be obtained. More preferably, the particles comprise a rigid foamed material such as insulation foams, such as for example, Tarecpir® M1 Rigid Polyisocyanurate Insulation foam (“Recticel PIR 33”) which has a density of 33 kg/m³. The benefit of selecting the insulation foam as a material for grinding the abrasive particles is improved fire safety of the foam which also makes it easier to store such foams in manufacturing facilities. Physical properties of exemplary foamed materials suitable for forming abrasive particles are set out below in Tables 1A to 1D below.

TABLE 1A
Tarecpir ® M1 Rigid Polyisocyanurate Insulation 33-80 kg/m³/2.1-5.0 lb/ft³
General Physical Properties (Metric)

| Property | Test Method | Unit | Typical Value | | | |
|---|---|---|---|---|---|---|
| Nominal Density | (EN ISO 845)/(ASTM D 1622) | kg/m³ | 33 | 40 | 60 | 80 |
| Thermal Conductivity at +10° C. | (EN 12667)/(ASTM C 518) | W/m · K | 0.026 | 0.026 | 0.026 | 0.029 |
| Colour | | | Green | Green | Green | Green |
| Closed Cell Content | (EN ISO 4590) Method 1/ | % | ≥95 | ≥95 | ≥95 | ≥95 |
| | (ASTM D 2856) Method B | | | | | |
| Operating Temperature Limits | Upper Limit | ° C. | +120 | +120 | +120 | +120 |
| | Lower Limit | ° C. | −200 | −200 | −200 | −200 |
| Minimum Compressive | (EN 826)/(ASTM D 1621) | | | | | |
| Strength at +23° C. | Parallel | kPa | 180 | 220 | 310 | 700 |
| | Perpendicular | kPa | 90 | 140 | 200 | 520 |
| Minimum Tensile | (ASTM D 1623) | | | | | |
| Strength at +23° C. | Parallel | kPa | 350 | 410 | 510 | 850 |
| | Perpendicular | kPa | 190 | 300 | 350 | 700 |
| Linear Dimensional Stability | (EN 1604)/(ASTM D 2126) | | | | | |
| | +93° C. for 24 hours | % | ≤1 | ≤1 | ≤1 | ≤1 |
| | −30° C. for 24 hours | % | ≤1 | ≤1 | ≤1 | ≤1 |
| | +70° C. for 48 hours and 95% RH | % | ≤3 | ≤3 | ≤3 | ≤3 |
| Friability for 10 mins | (ASTM C 421) | % | <40 | <35 | <35 | <20 |
| Linear Expansion Coefficient | (ASTM D 696) | m/m · K | 40-70 × 10⁻⁴ | 40-70 × 10⁻⁴ | 40-70 × 10⁻⁴ | 40-70 × 10⁻⁴ |
| Water Absorption | (ISO 2896) | Vol % | ≤5.0 | ≤5.0 | ≤5.0 | ≤6.0 |
| Water Vapour Permeability | (ASTM E 96) | ng/Pa · s · m | ≤5.5 | ≤5.5 | ≤5.5 | ≤5.5 |

TABLE 1B
Tarecpir ® HT Rigid Polyisocyanurate Insulation 40 kg/m³/2.5 lb/ft³
General Physical Properties (Metric)

| Property | Test Method | Unit | Typical Value |
|---|---|---|---|
| Nominal Density | (EN ISO 845)/(ASTM D 1622) | kg/m³ | 40 |
| Thermal Conductivity at +10° C. | (EN 12667)/(ASTM C 518) | W/m · K | 0.026 |
| Colour | | | Gris |
| Closed Cell Content | (EN ISO 4590) Methode 1/ | % | ≥95 |
| | (ASTM D 2856) Methode B | | |
| Operating Temperature Limits | Limite maximale | ° C. | +200 |
| | Limite minimale | ° C. | −180 |
| Minimum Compressive | (EN 826)/(ASTM D 1621) | | |
| Strength at +23° C. | Parallel | kPa | 230 |
| | Perpendicular | kPa | 150 |
| Minimum Tensile | (ASTM D 1623) | | |
| Strength at +23° C. | Parallel | kPa | 490 |
| | Perpendicular | kPa | 340 |
| Linear Dimensional Stability | (EN 1604)/(ASTM D 2126) | | |
| | +93° C. bij 24 hours | % | ≤1 |
| | −30° C. bij 24 hours | % | ≤1 |
| | +70° C. bij 24 hours and 95% RH | % | ≤3 |
| Friability for 10 mins | (ASTM C 421) | % | <40 |
| Linear Expansion Coefficient | (ASTM D 696) | m/m · K | 40-70 × 10 [symbol] |
| Water Absorption | (ISO 2896) | Vol % | ≤5.5 |
| Water Vapour Permeability | (ASTM E 96) | ng/Pa · s · m | ≤5.5 |

[symbol]

indicates data missing or illegible when filed

TABLE 1C
Tarecpir ® B2 Rigid Polyisocyanurate Insulation 33-60 kg/m³/2.1-3.75 lb/ft³
General Physical Properties (Metric)

| Property | Test Method | Unit | Typical Value | | |
|---|---|---|---|---|---|
| Nominal Density | (EN ISO 845)/(ASTM D 1622) | kg/m³ | 33 | 40 | 60 |
| Thermal Conductivity at +10° C. | (EN 12667)/(ASTM C 518) | W/m · K | 0.024 | 0.024 | 0.025 |
| Colour | | | Cream | Cream | Cream |
| Closed Cell Content | (EN ISO 4590) Method 1/ | % | ≤95 | ≤95 | ≤95 |
| | (ASTM D 2856) Method B | | | | |
| Operating Temperature Limits | Upper Limit | ° C. | +120 | +120 | +120 |
| | Lower Limit | ° C. | −180 | −180 | −180 |
| Minimum Compressive | (EN 826)/(ASTM D 1621) | | | | |
| Strength at +23° C. | Parallel | kPa | 180 | 250 | 430 |
| | Perpendicular | kPa | 90 | 150 | 230 |
| Minimum Tensile | (ASTM D 1623) | | | | |
| Strength at +23° C. | Parallel | kPa | 350 | 450 | 690 |
| | Perpendicular | kPa | 250 | 350 | 530 |
| Linear Dimensional Stability | (EN 1604)/(ASTM D 2126) | | | | |
| | +93° C. for 24 hours | % | ≤1 | ≤1 | ≤1 |
| | −30° C. for 24 hours | % | ≤1 | ≤1 | ≤1 |
| | +70° C. for 48 hours and 95% RH | % | ≤3 | ≤3 | ≤3 |
| Friability for 10 mins | (ASTM C 421) | % | <30 | <30 | <30 |
| Linear Expansion Coefficient | (ASTM D 696) | m/m · K | 40-70 × 10 [symbol] | 40-70 × 10 [symbol] | 40-70 × 10 [symbol] |
| Water Absorption | (ISO 2896) | Vol % | ≤5.0 | ≤5.0 | ≤5.0 |
| Water Vapour Permeability | (ASTM E 96) | ng/Pa · s · m | ≤5.5 | ≤5.5 | ≤5.5 |

[symbol]

indicates data missing or illegible when filed

TABLE 1D
Tarecpir ® CR Rigid Polyisocyanurate Insulation 42-50 kg/m³/2.6-3.1 lb/ft³
General Physical Properties (Metric)

| Property | Test Method | Unit | Typical Value | | | |
|---|---|---|---|---|---|---|
| Nominal Density | (EN ISO 845)/(ASTM D 1622) | kg/m³ | 42 | 46 | 48 | 50 |
| Thermal Conductivity at +10° C. | (EN 12667)/(ASTM C 518) | W/m · K | 0.026 | 0.026 | 0.026 | 0.026 |
| Colour | | | Green | Green | Green | Green |
| Closed Cell Content | (EN ISO 4590) Method 1/ | % | ≥95 | ≥95 | ≥95 | ≥95 |
| | (ASTM D 2856) Method B | | | | | |
| Operating Temperature Limits | Upper Limit | ° C. | +120 | +120 | +120 | +120 |
| | Lower Limit | ° C. | −200 | −200 | −200 | −200 |
| Minimum Compressive | (EN 826)/(ASTM D 1621) | | | | | |
| Strength at +23° C. | Parallel | kPa | 260 | 310 | 320 | 340 |
| | Perpendicular | kPa | 180 | 200 | 220 | 230 |
| Minimum Tensile | (ASTM D 1623) | | | | | |
| Strength at +23° C. | Parallel | kPa | 430 | 490 | 500 | 510 |
| | Perpendicular | kPa | 330 | 380 | 390 | 400 |
| Linear Dimensional Stability | (EN 1604)/(ASTM D 2126) | | | | | |
| | +93° C. for 24 hours | % | ≤1 | ≤1 | ≤1 | ≤1 |
| | −30° C. for 24 hours | % | ≤1 | ≤1 | ≤1 | ≤1 |
| | +70° C. for 48 hours and 95% RH | % | ≤3 | ≤3 | ≤3 | ≤3 |
| Friability for 10 mins | (ASTM C 421) | % | <30 | <30 | <30 | <25 |
| Linear Expansion Coefficient | (ASTM D 696) | m/m · K | 40-70 × 10⁻⁴ | 40-70 × 10⁻⁴ | 40-70 × 10⁻⁴ | 40-70 × 10⁻⁴ |
| Water Absorption | (ISO 2896) | Vol % | ≤5.0 | ≤5.0 | ≤5.0 | ≤5.0 |
| Water Vapour Permeability | (ASTM E 96) | ng/Pa · s · m | ≤5.5 | ≤5.5 | ≤5.5 | ≤5.5 |

By incorporating non-spherical abrasive particles 3 comprising the abovementioned foamed material into the foam 2, the physical properties of the foamed material used to form the abrasive particles are incorporated into the foam 2 in the sponge and this results in a sponge with modified foam properties and improved abrasive properties relative to a sponge without particles. Preferably, the abrasive particles may be distributed throughout the foam. An advantage is cleaning homogeneity as the foam is typically manufactured in the form of sheets from which individual sponges will be cut. A good dispersion of the particles is needed to ensure that every cut sponge will be featuring homogenous and effective cleaning. To achieve this, there is controlled dispersion of the particles in the foaming resin (for grinded particles) or in the slurry (for extruded particles). Specifically, to ensure that there are always enough particles at the surface to deliver the cleaning provided, the particle load in the foaming resin (grinded particle) or in the slurry (for extruded particle) is in an amount of from about 0.1% to about 30%, preferably from about 0.5% to about 20%, more preferably from about 1% to about 10%, most preferably from about 1% to about 5% by the total weight of the foaming resin and the abrasive particles. Another advantage is a method of making a sponge can be simplified, i.e. there is no need for assembly of components of a sponge in multiple phases and no need for control of localized particle distribution on the foam.

Further, an advantage of making a homogenously dispersed particle loaded sponge which will still be homogenous after the foam is sliced in a sheet is that the sheet may be laminated with a normal sponge so the particles could be effective at any of the surfaces of a sponge.

Preferably, the abrasive particles may be dispersed adjacent an outer surface of the foam. The advantage is to provide a sponge 1 which can be produced in a simple way at low cost, and which permit effective cleaning while not leading to scratching of dish surfaces. Specifically, having particles concentrated near the surface rather than dispersed throughout entire sponge is that cleaning action happens at sponge surface, hence particles in middle of sponge will not reach the surface to be cleaned and as such do not contribute to cleaning action while adding cost of sponge production.

FIG. 9 shows a composite sponge 60 comprising a first layer 1 comprising a sponge 1 substantially described in FIG. 1 and a second foam layer 61 is bonded to the first layer 1. A material of the second foam layer 61 may comprise a cellulose, polyurethane or polyvinyl alcohol (PVA) foam. The second foam layer 61 may be made according to known foaming processes described below. For example, the foam structures of the second foam layer 61 are typically achieved via a gas expansion process, e.g.: either by injecting gas or solvent within the abrasive precursor and allowing expansion by pressure drop and/or increase of temperature, e.g.: extrusion foaming process. In that case, thermoplastic materials in a form of pure polymer or polymer blend or plasticized polymers or the like, are usually used. Typical examples of thermoplastic polymers are, without being exhaustive: polyethylene, polypropylene, PVC, polycarbonate, polyurethane, polyacrylate, polystyrene, polyesters, polyamide, etc. Lists of alternative thermoplastic polymers can be found in extrusion foaming or gas foaming literature (for examples see the books “Thermoplastic Foam Extrusion” by James L. Throne or “Foam Extrusion: Principles and Practice by Shau-Tarng Lee). Typical gases used in such processes are air, nitrogen, carbon dioxide or organic solvents such as pentane, cyclopentane, or the like with or without inclusion of nucleation and foam stabilizing agents. In most cases, a controlled amount of gas is allowed to dissolve into the polymer/polymeric mix into in melted phase whereas the skilled operator can control accurately the foaming parameters e.g.: formulation, time/temperature/pressure cycle parameters to target specific foam structures.

It will be appreciated by the person skilled in the art that foaming processes and foam structures may be achieved via emulsion foaming of monomers followed by a hardening step via chemical, heat or radiative, e.g.: UV, curing and if necessary followed by a drying step of the solidified foam. Several monomer types are possible to use e.g.: those derived from the non-exhaustive list of the following monomer structures e.g.: vinyl, styrene, acrylate, methacrylate, diene, etc. Examples of materials and foaming and curing process are extensively described in literature (e.g.: refer to the book “Emulsion Polymer Technology” by Robert D. Athey). A preferred route for production of the foam is to form a water/oil High Internal Phase Emulsion of water in the monomer mixture and polymerize in-situ, as described in U.S. Pat. No. 6,369,121 to Catalfamo et al, incorporated by reference herein. In a preferred embodiment the foam is produced after polymerization of a divinyl benzene cross-linked styrene polymer using a water/oil High internal Phase Emulsion process.

Foaming processes and foam structures are also typically achieved by mechanical agitation e.g.; battering of a viscous mix e.g.: typically including protein with emulsifying and possibly stabilizing features followed by a step of curing/hardening and if necessary drying of the solidified foam. Non-exhaustive examples of proteins are white egg or pure albumen, gelatin, saponin, gluten, soybean protein, globulin, prolamine, glutelin, histone, protamine, etc. whereas the proteins are often agitated in presence of water, emulsifying agent, stabilizers e.g.: alginic acid, and, very desirably, a significant amount of polymerizable monomer and/crosslinker to achieve sufficient hardness of the foam. For further reference refer to the book “Functionality of Proteins in Food” by Joseph F. Zayas, “Protein Functionality in Food Systems” from Hettiarachchy, Article in Journal of Cereal science 47 (2008) 233-238 by E. Zukowska et Al; or US2006/0065159.

Particularly preferred foaming processes and foam structures are also typically achieved by simultaneous polymerization, with or without crosslinking of monomers, coupled with in-situ production of expanding gas. Such a process is typically used to produce polyurethane foam. Processes, polyurethane precursors, formulations, additives, etc. are abundantly described in literature as well as, most conveniently, their impact on the various critical foam structure parameters, such as foam density, cell size, content of closed cell, strut aspect ratio and to some extent foam hardness which producing. Much information on polyurethane formulation and production processes is available in literature (see for reference following the books: “Rigid polyurethane/polyisocyanurate foam processing” by Robert Wood “Polyurethane and Related Foams: Chemistry and Technology” by Kaneyoshi Ashida and “Chemistry and technology of polyols for polyurethanes” by Mihail Ionescu).

### Method of Manufacture

The present invention also relates to a method of manufacturing a sponge for cleaning dish surfaces, the method comprising:
mixing abrasive particles in a foaming resin in an amount from about 0.1% to about 30%, preferably from about 0.5% to about 20%, more preferably from about 1% to about 10%, most preferably from about 1% to about 5% by the total weight of the foaming resin and the abrasive particles at a temperature of between about 10° C. and about 150° C. degrees C. for a time period of between about 0.5 minutes and about 60 minutes;
allowing the foaming resin comprising the abrasive particles to rise to form a sponge comprising a foam selected from the group consisting of: polyurethane foam, cellulose foam, polyvinyl alcohol (PVA) foam; and
curing the foam for a time period of between about 0.5 and about 48 hours at a temperature between about 10° C. and about 50° C. to form the sponge; wherein the abrasive particles are solid and comprise a mean solidity from about a mean solidity from about 0.4 to about 0.75, preferably from about 0.5 to about 0.7, and more preferably from about 0.55 to about 0.65.

An advantage of the above method is that a sponge can be produced during in a single process of co-foaming of a foam resin and abrasive particles, i.e. in-situ foaming. As the sponge has improved abrasive properties, there is no longer a need for attaching additional piece of scouring pad thereby improving manufacturability of the sponge.

Preferably, the abrasive particles may be mixed in the foaming resin for a mixing time sufficient to obtain a homogeneous abrasive particle distribution within the foaming resin. The mixing time may be adapted according to a viscosity of the foaming resin and a molecular weight of the abrasive particles. For the purposes of efficient cycle time during manufacturing, the mixing time is typically between about 0.5 minutes and about 60 minutes.

The rising of the foam relates to the reaction of the foaming resin which introduces gas to expand the foam into the sponge. As the rising and curing steps are dependent on the components used to form the foaming resin and would be substantially similar to the rising and curing steps in processes for preparing foamed materials such as polyurethane, polyvinyl alcohol and cellulose are known to a skilled person, it will not be further described.

The foaming resin may comprise a polyurethane reaction mixture prepared by mixing an isocyanate component and an isocyanate reactive component, wherein at least a portion of the abrasive particles are dispersed in the isocyanate reactive component before mixing it with the isocyanate component.

Preferably, the foaming resin is prepared by mixing an isocyanate component and an isocyanate reactive component, wherein the isocyanate reactive component comprises isocyanate reactive compounds comprising, per 100 parts by the total weight of the foaming resin and the abrasive particles, a) 50 to 200 parts of one or more polyetherpolyols with the OH number 48 mg of KOH/g and an average functionality of 1.5 to 4;
b) 0.2 to 10 parts of an amine catalyst;
c) 0.01 to 2 parts of a tin catalyst; and
d) 0.1 to 5 parts of a silicone surfactant.

The abrasive particles may be obtained from grinding foams or extruding a thermoplastic or an elastomer material and details of each process is described below.

### Abrasive Particles Formed by Grinding Foams

The applicant has found that the abrasive particles 3 may be obtained from grinding foams which typically result in abrasive particles 3 with sharp edges that are the result of the foaming process. Blowing agents, either gas or volatilized solvent optionally with/without addition of surfactants or polymeric agents, help during the foaming process to sharpen the foam material edges (or struts) owing to the curvature of the expanding bubble.

Preferably, the abrasive particles may be composed of the same foam material as the foam 2 or a different foam material. The abrasive particles may be made from preferably rigid polyurethane or polyisocyanurate foam which may contain some superficial reactive chemical groups e.g.: hydroxyl, amino or cyanate groups as residue from the chemical reactants, as well as urethane or isocyanurate group formed during the foaming of the rigid foam. Further, when formulating a target exact reagent stoichiometry, the formulation of the rigid foam off-stoichiometry may be adapted so to yield more cross-linkable chemical groups at the surface of the rigid foam and of the particles after grinding the foam. These reactive groups present at the surface of the ground particles are highly reactive with the isocyanate chemicals that is used to foaming and forming the foam so the particles will be bound or attached both chemically and mechanically to the foam.

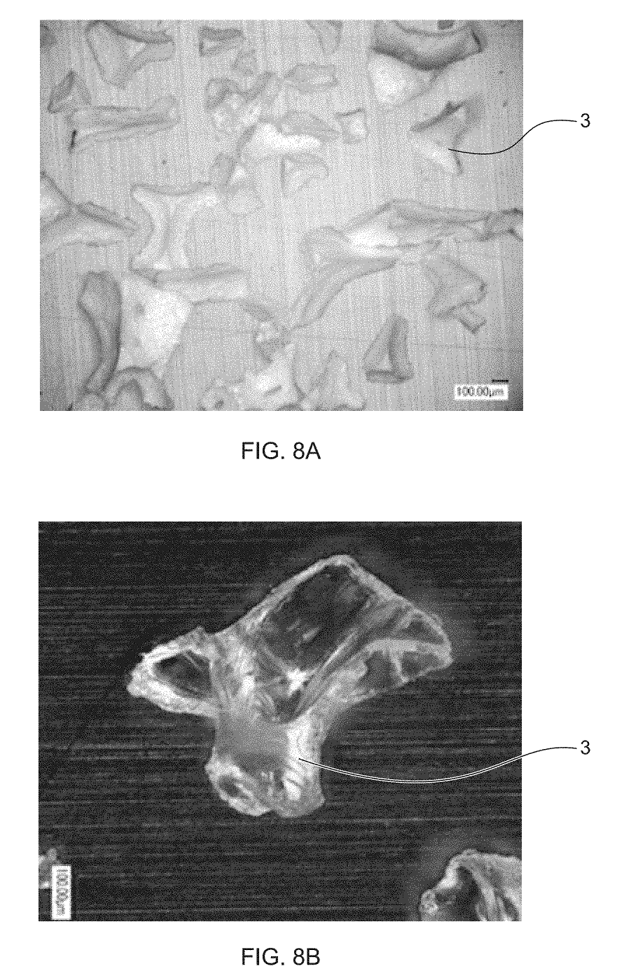

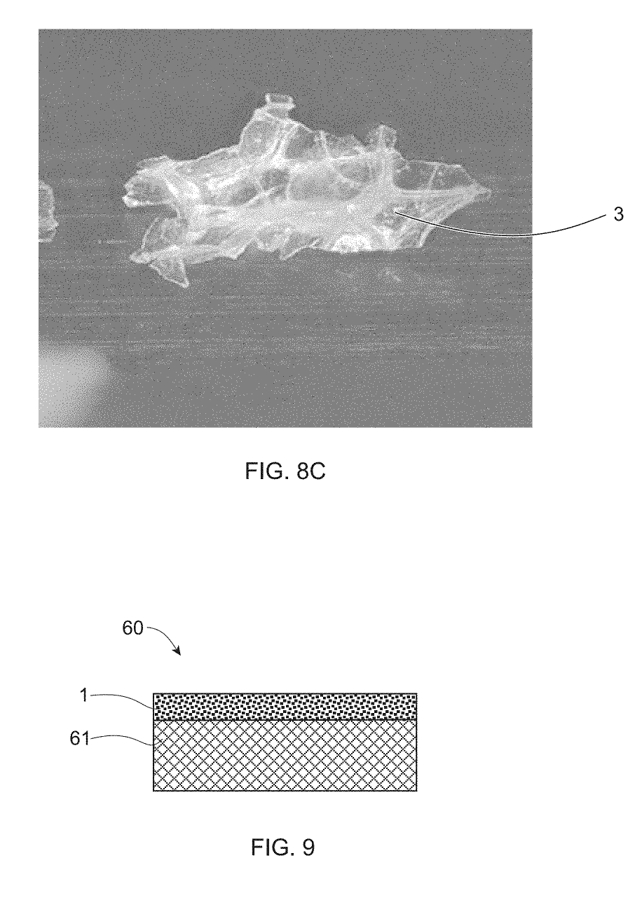

Incidentally, the abrasive material may be produced from organic foams and even from mineral foams although pragmatically mineral foams are less common unless mineral materials are co-foamed, e.g.: as filler in a typical foaming process with otherwise known foamable organic or polymeric materials. Similarly, non-mineral abrasive material can also be co-foamed with otherwise known foamable organic or polymeric materials. The abrasive raw material per se e.g.: mineral or non-mineral filler may be dispersed within a matrix prior to undergoing the foaming process to achieve the adequate foam structure. In that case, the material used as filler in foaming processes may comprise organic or inorganic salt abrasives such as carbonate-derived salts, phosphate-derived salts, pyrophosphate-derived salts, silica or alumina derived salts, hydroxyapatite, diatomaceous, fuller earth, talc, etc., polymeric material derived from polyethylene, polypropylene, PVC, polycarbonate, melamine, urea, polyurethane, polyacrylate, polystyrene, phenolic, polyesters, polyamide, or natural material derived from cellulose, lingo-cellulose or shell, such as nut shell, kernel, wood, bamboo, plants, etc. FIG. 8A is a photograph of exemplary abrasive particles 3 made from mineral foam (cured kaolin). FIG. 8B is a photograph of an exemplary abrasive particle 3 made from polylactic. FIG. 8C is a photograph of an exemplary abrasive particle 3 made from polyhydroxybutyrate-co-valerate (PHBV). It will be appreciated that the exemplary abrasive particles 3 are non-spherical as seen from FIGS. 8A to 8C.

More preferably the abrasive particles are made from the rigid polyurethane foam made from the diisocyanate (e.g. Lupranate M200R or Lupranate M20S) and diol (Lupranol 3423).

The applicant has found that efficacious and safe cleaning particles can be produced from foams with additional structural parameters as described below. The foams for making the abrasive particles are made by known methods as described in the above with respect to the foam layer 61. Indeed the applicant has found that the structure of the foam allows the shape parameters of the cleaning particles to be controlled and the applicant has demonstrated that the particle shape parameters greatly impact the cleaning performance of the particles. It is understood that the foam structural parameters described below have a direct impact on the desired particle shape after grinding of the foam into abrasive particles; hence the accurate control of the foam structure is a preferred and convenient means to synthesized efficient abrasive particles.

### Foam Cell Size:

Similarly, the applicant has found that a good cleaning effect can be achieved with abrasive particles which have been made from foams featuring cell sizes ranging from 20 micrometers to 2000 micrometers. However the applicant has surprisingly found that a significantly better cleaning effect can be achieved with foams featuring cell sizes between 100-1000 micrometers, more preferably from 200 to 500 micrometers and most preferably from 300 to 450 micrometers. Foam cell size can be measured for instance using the protocol described in ASTM D3576.

### Foam Closed Cell Content:

Similarly, the applicant has found that a good cleaning effect can be achieved with abrasive particles which have been made from foams featuring close-cell structures. However, the applicant has surprisingly found that a significantly better cleaning effect can be achieved with abrasive cleaning particles, which have been reduces into particles from foams with open-cell structure. An open-cell foam structure presents the opportunity to form well defined sharp struts, which in turn produce effective abrasive particles.

Efficient cleaning particles are therefore produced by grinding the foam structure with special care to target size and shape. Hence for instance, when large particle size is desired, foam with large cell size is desirable and vice-et-versa. Additionally, in order to preserve an optimal particle shape while grinding the foam structure, it is recommended to not target particle size excessively below the dimension of the cell size of the foam. Typically, the applicant recommends targeting particle size not below about half of the foam cell size. The applicant has found that excessive particle reduction e.g.: vis-à-vis the original foam structure and especially vis-à-vis the cell size yields rounder particles with sub-optimal cleaning efficiency.

In practice, the process to reduce the foam into particle population is set such as the amount of particles with size below half of the average foam cell size is below 30% by weight, preferably below 20% more preferably below 10% and most preferably no particles are detected, whereas the particle size weight proportion is defined by physical sieving method. Note: In order to proceed to the separation of the particles based on size related to half of the average foam cell size, a tolerance of 10% is accepted for the selection of the sieving mesh vis-à-vis the theoretical target sieving grid. The selected sieving mesh tolerance is valid for smaller available sieving mesh vs. the theoretical target size.

One suitable way of reducing the foam to the abrasive cleaning particles herein is to grind or mill the foam. Other suitable means include the use of eroding tools such as a high speed eroding wheel with dust collector wherein the surface of the wheel is engraved with a pattern or is coated with abrasive sandpaper or the like to promote the foam to form the abrasive cleaning particles herein.

Alternatively and in a highly preferred embodiment herein, the foam may be reduced to particles in several stages. First the bulk foam can be broken into pieces of a few cm dimensions by manually chopping or cutting, or using a mechanical tool such as a lump breaker, for example the Model 2036 from S Howes, Inc. of Silver Creek, N.Y.

### Abrasive Particles Formed by Extruding

Preferably, the abrasive particles may be produced by extruding a thermoplastic material, through an extruder nozzle orifice along an extruding axis, and. slicing the extruded thermoplastic material to form extruded abrasive particles having a predetermined length (L). In one embodiment, the extruder nozzle orifice has a predetermined cross-sectional shape on a plane perpendicular to the extruding axis. The predetermined cross-sectional shape may be the inverse image of the predetermined cross-sectional shape of the extruded abrasive particle. In one embodiment, the material comprises a thermoplastic material or curable mineral comprising slurry.

Preferably, the temperature at the nozzle is kept at a temperature Tn, wherein Tn=Tm−T, and T is greater than 20° C., Tm being the melting temperature of said thermoplastic material. Preferably, T is between 30 and 180° C. More preferably, T is between 80 and 150° C.

### Method of Cleaning

The present invention further relates to a method of cleaning a dish surface comprising soil on the dish surface with the sponge according to the present invention.

The method comprises the steps of wetting the sponge with water, applying a dishwashing detergent composition, preferably liquid hand dishwashing liquid composition, typically in diluted or neat form to the sponge, and contacting the soiled surface of the dish with a sponge according to the present invention. The sponge may be immersed in the detergent composition and water mixture prior to being contacted with the dish surface. The contacting of the sponge to the dish surface is preferably accompanied by a concurrent scrubbing of the dish surface.

### Examples

Examples shown herein are to exemplify the present invention, but are not necessarily used to limit or otherwise define the scope of the present invention. Specifically, sponges of the present invention are made comprising ingredients listed in the following tables according to the listed proportions. Table 2 shows ingredients for making sponges according to the present invention (“Inventive Examples 1, 2”). The abrasive particles in the Inventive Examples 1, 2 below are formed from grinding rigid foam, preferably polyurethane rigid foam having a density comprised between 25 to 120 kg/m³ and a compressive strength of 80 kPa (0.8 kg/cm²) up to 300 kPa (3 kg/cm²) with 10% deformation measured according to EN 826. Particles may be ground to a size defined by a mean ECD of about 100 to about 500 μm. In the Inventive Examples 1, 2, a rigid foam available commercially as Recticel PIR 33 is used as the raw foam material for making the abrasive particles and the particles are prepared by grinding the foam material to a size range defined by a mean ECD of about 250 to 355 μm as measured according to the area-equivalent diameter (ISO 9276-6:2008(E) section 7) as implemented via the Occhio Nano 500 Particle Characterisation Instrument with its accompanying software Callistro version 25 (Occhio s.a. Liege, Belgium).

TABLE 2

| Part A (isocyanate) | Part B (Polyol) |
|---|---|
| Desmodur T65 30 parts | Lupranol 2084 65 parts |
| | Amine catalyst 2.6 parts |
| | Tin catalyst 0.7 parts |
| | Niax silicon surfactant 0.6 parts |
| | Abrasive Particles made from Recticel PIR 33 |
| | (mean ECD of 250 to 355 microns) 1% to 5% |
| | by the total weight of a foaming resin (Part |
| | A plus Part B) and the abrasive particles. |

### Detailed Description for Symbol for Raw Material in Table 2:

Desmodur T65=Isocyanate for polyurethane (PU) flexible foam product, toluene diisocyanate (TDI) for the production of PU flexible foam like polyester or visco-elastic foams
Lupranol 2084=Polyethylpolyols with the OH number 48 mg of KOH/g and an average functionality of 1.5 to 4
Niax Silicon Surfactant=Additive for foam production
Recticel PIR 33=rigid polyurethane foam particles having a Shore D hardness of 90, solidity of 0.65 and circularity of 0.42.

In order to prepare the sponge according to the invention, the abrasive particles are mixed with a foaming resin, preferably a polyurethane foaming resin wherein the resin preferably comprises a reactive isocyanate and a polyol together with foaming agent and additives. The amount of particles within the sponge is between 0.5 to 30%, preferably 1 to 20%, more preferably 5 to 10%, most preferably 1 to 5% of the total weight of the abrasive particles and the foaming resin used to manufacture the sponge. Specifically, each of the sponges according to Inventive Examples 1 and 2 are made by mixing abrasive particles in the foaming resin in an amount of 1% to 5%, by the total weight of the foaming resin and the abrasive particles at a room temperature of about 25° C. for about 3 minutes. After mixing, the foaming resin comprising the abrasive particles is allowed to rise to form the sponge with the abrasive particles embedded therein and integral therewith and the rising time is approximately 30 seconds. After rising, the sponge is cured for 48 hours at 25° C.

### Cleaning Effectiveness Test Method:

Ceramic tiles (typically glossy, white, ceramic 24 cm×4 cm) are covered with 0.3 g of typical greasy soap scum soils mainly based on calcium stearate and artificial body soils commercially available (applied to the tile via a sprayer). The soiled tiles are then dried in an oven at a temperature of 140° C. for 10 to 45 minutes, preferably 40 minutes and then aged between 2 and 12 hours at room temperature (around 20° C.) in a controlled environment humidity (60-85% RH, preferably 75% RH). Then the soiled tiles are cleaned using 5 ml of the cleaning lotion poured directly on the sponge pre-wetted with water. The sponge is then mounted on a Wet Abrasion Scrub Tester Instrument (such as made by Sheen Instruments Ltd. Kingston, England). The abrasion tester can be configured to supply pressure (e.g.: 600 g), and move the sponge over the test surface with a set stroke length (e.g.: 30 cm), at set speed (e.g.: 37 strokes per minute). The ability of the sponge to remove greasy soap scum is measured through the number of strokes needed to perfectly clean the surface, as determined by visual assessment. The lower the number of strokes, the higher the greasy soap scum cleaning ability of the sponge.

Table 3 shows cleaning data of cleaning with Inventive Examples according to the present invention, and a Reference Example made of the polyurethane sponge.

TABLE 3
Cleaning Greasy Soap Scum with a liquid detergent composition

| | Sponges Evaluated | | |
|---|---|---|---|
| | Reference | Inventive Example #1 | Inventive Example #2 |
| | Example | 1% PIR 33 | 5% PIR 33 |
| | (no particle) | (ECD of 250-355 μm) | (ECD of 250-355 μm) |
| Foamed Material | Polyurethane | Polyurethane | Polyurethane |
| Number of strokes | 22 | 18 | 15 |
| Particle Hardness Shore D | — | 90 | 90 |
| Solidity | — | 0.65 | 0.65 |
| Circularity | — | 0.42 | 0.42 |

The above results show that sponges with the abrasive particles having a solidity falling within the claimed range of 0.4 to 0.75 results in a less number of cleaning strokes than a conventional sponge without particles. In other words, it is easier to clean with sponges according to the present invention due to improved abrasive properties and effective cleaning from the solidity of the particles whereas it is more difficult to clean the soil from the surfaces with a conventional sponge without particles in view of the higher number of cleaning strokes.

Table 4 shows a list of abrasive particles and properties of the abrasive particles suitable for making a sponge according to the present invention. In an aspect of the present invention, the abrasive particle shown below may be grinded from rigid polyurethane foam (controlled foam structure e.g.: foam density, cell size, strut aspect ratio and % cell size content). Polyurethane foam is synthesized from reaction of a diisocyanate (e.g.: base on polymeric methylene diphenyl diisocyanate) and polyols (e.g.: polyether or polyester-based polyol). The diisocyanate may be, for example, Lupranate M200R from BASF and the polyol may be, for example Lupranol 3423 from BASF. The rigid polyurethane foam is grinded into small particles and is sieved using a rotary mill and particle selection is done with used of air jet sieving instrument from Retsch.

TABLE 4

| Particle Example(s) | Mean Area-Equivalent | Mean | Mean |
|---|---|---|---|
| comprising | Diameter (ECD) | Solidity | Circularity |
| Polyurethane Foam | (200 μm to 400 μm) | (0.4 to 0.75) | (0.1 to 0.6) |
| 1 | 238 μm | 0.59 | 0.19 |
| 2 | 216 μm | 0.66 | 0.23 |
| 3 | 212 μm | 0.66 | 0.25 |

Tables 5A to 5E show a list of abrasive particles made from extrusion of a thermoplastic or elastomeric material. The abrasive particles comprise the specified solidity and the ratio L/ECD for which the respective technical effects and advantages have been described earlier in the description with reference to the relevant figures.

TABLE 5A

| | Particle Example# | | | | | |
|---|---|---|---|---|---|---|
| | 1 | 2 | 3 | 4 | 5 | 6 |
| Raw material | PU | PHB | PHB | PHB | PHB | PHBV |
| Ratio L/ECD | 1.5 | 1 | 1.5 | 2 | 3 | 0.5 |
| (ECD of Cross | | | | | | |
| Section of | | | | | | |
| Extruded Fiber) | | | | | | |
| Solidity | 0.65 | 0.8 | 0.35 | 0.50 | 0.75 | 0.65 |
| (cross-section) | | | | | | |
| Particle Area- | 250 | 250 | 150 | 200 | 100 | 350 |
| equivalent | | | | | | |
| diameter | | | | | | |
| “ECD” (in μm) | | | | | | |

TABLE 5B

| | Particle Example continued # | | | | | |
|---|---|---|---|---|---|---|
| | 7 | 8 | 9 | 10 | 11 | 12 |
| Raw material | PHBV | PHBV | PHBV | PHBV | PLA | PLA |
| Ratio L/ECD | 1 | 1.5 | 2 | 2.5 | 0.8 | 1.5 |
| Solidity | 0.70 | 0.55 | 0.25 | 0.50 | 0.65 | 0.70 |
| (cross-section) | | | | | | |
| Particle Area- | 100 | 200 | 250 | 250 | 300 | 400 |
| equivalent | | | | | | |
| diameter | | | | | | |
| “ECD” (in μm) | | | | | | |

TABLE 5C

| | Particle Example continued # | | | | | |
|---|---|---|---|---|---|---|
| | 13 | 14 | 15 | 16 | 17 | 18 |
| Raw material | PLA | PCL | PCL | PBS | PBAT | PBAT |
| Ratio L/ECD | 2 | 1 | 1.7 | 0.5 | 1 | 1.5 |
| Solidity | 0.55 | 0.65 | 0.50 | 0.50 | 0.35 | 0.35 |
| (cross-section) | | | | | | |
| Particle Area- | 125 | 400 | 250 | 300 | 250 | 200 |
| equivalent | | | | | | |
| diameter | | | | | | |
| “ECD” (in μm) | | | | | | |

TABLE 5D

| | Particle Example cntd. # | | | | | |
|---|---|---|---|---|---|---|
| | 19 | 20 | 21 | 22 | 23 | 24 |
| Raw material | PBAT | TPS | KAO | CAC | BAS | MICA |
| Ratio L/ECD | 2 | 1.5 | 2 | 2 | 1.5 | 1.5 |
| Solidity | 0.8 | 0.55 | 0.6 | 0.5 | 0.65 | 0.6 |
| (cross-section) | | | | | | |
| Particle Area- | 300 | 200 | 25 | 20 | 15 | 20 |
| equivalent | | | | | | |
| diameter | | | | | | |
| “ECD” (in μm) | | | | | | |

TABLE 5E

| | Particle Example continued # | | | | | |
|---|---|---|---|---|---|---|
| | 25 | 26 | 27 | 28 | 29 | 30 |
| Raw material | TALC | KAOb | CACb | BASb | MICAb | TALCb |
| Ratio L/ECD | 2.5 | 1.5 | 1.5 | 2 | 2 | 2 |
| Solidity | 0.55 | 0.5 | 0.7 | 0.25 | 0.35 | 0.5 |
| (cross-section) | | | | | | |
| Particle Area- | 15 | 200 | 250 | 300 | 250 | 250 |
| equivalent | | | | | | |
| diameter | | | | | | |
| “ECD” (in μm) | | | | | | |

Symbol for Raw Material in Tables 4A to 4E:

PU=Polyurethane (CAS number 53862-89-8 or 57029-46-6)
PHB=Polyhydroxybutyrate (CAS number 26063-00-3 ex.: from Tianan or Biomer)
PHBV=Polyhydroxybutyrate-co-valerate (CAS number 80181-31-3 ex.: from Tianan or Biomer)
PLA=Polylactic acid (CAS number 26100-51-6 ex.: from NatureWorks)
PCL=Polycaprolactone (CAS number 24980-41-4 ex.from Perstorp)
PBS=Polybutylene succinate (CAS number 10034-55-6.ex.: from CSM)
PBAT=Polybutylene adipate terephtalate (CAS number 10034-55-6.ex.: from BASF)
TPS=Thermoplastic starch (CAS number 9005-25-8 e.g.: from Aldrich)
KAO=Kaolinite (CAS number 1318-74-7 from Aldrich). Note: extruded from water slurry 30-60% solid content and dry/cured after extrusion in 500-1200° C. temperature range
CAC=Calcium Carbonate (CAS number 471-34-1 from Aldrich). Note: extruded from water slurry 30-60% solid content and dry/cured after extrusion in 500-1200° C. temperature range
BAS=Barium sulfate (e.g.: CAS number 7727-43-7 from KOBO or Aldrich). Note: extruded from water slurry 30-60% solid content and dry/cured after extrusion in 500-1200° C. temperature range
MICA=Mica (e.g.: CAS number 12001-26-2 sieved or commuted from Mica Y1800, Y3000, S25 from KOBO). Note: extruded from water slurry 30-60% solid content and dry/cured after extrusion in 500-1200° C. temperature range
TALC=Talc (CAS number 14807-96-6 sieved or commuted from Kobo AJM, Ex-15, CT-250 or from Imerys OOSC, Superior M10 DEC). Note: extruded from water slurry 30-60% solid content and dry/cured after extrusion in 500-1200° C. temperature range
KAOb=Blend 50% Kaolinite (CAS number 1318-74-7 from Aldrich) and 50% Carnauba wax (CAS number 8015-86-9 from Aldrich). Note: extruded from water slurry 30-60% solid content and dry/cured after extrusion in 500-1200° C. temperature range
CACb=Blend 50% Calcium Carbonate (CAS number 471-34-1 from Aldrich) and 50% Carnauba wax (CAS number 8015-86-9 from Aldrich)
BASb=Blend 50% Barium sulfate (e.g.: CAS number 7727-43-7 from KOBO or Aldrich) and 50% Carnauba wax (CAS number 8015-86-9 from Aldrich)
MICAb=Blend 50% Mica (e.g.: CAS number 12001-26-2 sieved or commuted from Mica Y1800, Y3000, S25 from KOBO) and 50% Carnauba wax (CAS number 8015-86-9 from Aldrich)
TALCb=Blend 50% Talc (CAS number 14807-96-6 sieved or commuted from Kobo AJM, Ex-15, CT-250 or from Imerys OOSC, Superior M10 DEC) and 50% Carnauba wax (CAS number 8015-86-9 from Aldrich)

In an example, there is:

A. A sponge for cleaning dish surfaces, the sponge comprising:
a foam selected from the group consisting of: polyurethane foam, cellulose foam, polyvinyl alcohol (PVA) foam; and
abrasive particles disposed within the foam in an amount of from about 0.1% to about 30%, preferably from about 0.5% to about 20%, more preferably from about 1% to about 10%, most preferably from about 1% to about 5% by weight of the sponge, wherein the abrasive particles are solid and comprise a mean solidity from about 0.4 to about 0.75, preferably from about 0.5 to about 0.7, and more preferably from about 0.55 to about 0.65.
   B. The sponge according to A, wherein the abrasive particles comprise a material selected from the group consisting of: polyethylene, polypropylene, PVC, polycarbonate, melamine, urea, polyurethane, polyacrylate, polystyrene, phenolic, polyesters, polyamide, cellulosic polymers, polyhydroxyalkanoate, polylactic, polybutylenesuccinate, polycaprolactone, minerals and mixtures thereof.
   C. The sponge according to A, wherein the foam comprises a pore size from about 200 μm to about 5000 preferably from about 300 μm to about 2000 more preferably from about 400 to about 1000 μm and the abrasive particles comprise a mean Equivalent Circle Diameter (ECD) from about 10 μm to about 1000 preferably from about 20 μm to about 600 more preferably from about 100 μm to about 600 most preferably from about 200 μm to about 400 μm.
   D. The sponge according to A, wherein a circularity of the abrasive particles is from about 0.1 to 0.6, preferably from about 0.2 to 0.5, and more preferably from about 0.25 to 0.45.
   E. The sponge according to A, wherein the abrasive particles have a mean Shore® D hardness between 40 and 90.
   F. The sponge according to A, wherein a material of the abrasive particles are made from a foamed polyurethane material comprising a density of from about 25 kg/m³ to about 120 kg/m³ and a compressive strength of from greater than or equal to 80 kPa (0.8 kg/cm²) to less than or equal to 300 kPa (3 kg/cm²) with 10% deformation measured according to EN 826.
   G. The sponge according to A, wherein each of the abrasive particles are made from extruded fibers and comprise extruded protrusions having a longitudinal length (L) extending parallel to an extrusion axis of the extruded fibers and defining a cross-section of the abrasive particle perpendicular to the extrusion axis.
   H. The sponge according to G, wherein the cross-section of the abrasive particle comprises a mean solidity from about 0.4 to about 0.75, preferably from about 0.5 to about 0.7, and more preferably from about 0.55 to about 0.65, and wherein the ratio of said length (L) to an ECD of the cross section of the abrasive particle is from about 0.5 to about 3, preferably from about 1 to about 2.5, more preferably from about 1.5 to about 2.
   I. The sponge according to A, wherein the abrasive particles are distributed throughout the foam.
   J. The sponge according to A, wherein the abrasive particles are dispersed adjacent an outer surface of the foam.
   K. A composite sponge for cleaning dish surfaces, the composite sponge comprising:
a first layer comprising a sponge according to A; and
a second foam layer bonded to the first layer.
   L. A method of manufacturing a sponge for cleaning dish surfaces, the method comprising:
mixing abrasive particles in a foaming resin in an amount from about 0.1% to about 30%, preferably from about 0.5% to about 20%, more preferably from about 1% to about 10%, most preferably from about 1% to about 5% by the total weight of the foaming resin and the abrasive particles at a temperature of between about 10° C. and about 150° C. degrees C. for a time period of between about 0.5 minutes and about 60 minutes;
allowing the foaming resin comprising the abrasive particles to rise to form a sponge comprising a foam selected from the group consisting of: polyurethane foam, cellulose foam, polyvinyl alcohol (PVA) foam; and
curing the foam for a time period of between about 0.5 and about 48 hours at a temperature between about 10° C. and about 50° C. to form the sponge; wherein the abrasive particles are solid and comprise a mean solidity from about 0.4 to about 0.75, preferably from about 0.5 to about 0.7, and more preferably from about 0.55 to about 0.65.
   M. The method according to L, wherein the abrasive particles comprise a material selected from the group consisting of: polyethylene, polypropylene, PVC, polycarbonate, melamine, urea, polyurethane, polyacrylate, polystyrene, phenolic, polyesters, polyamide, cellulosic polymers, polyhydroxyalkanoate, polylactic, polybutylenesuccinate, polycaprolactone, minerals and mixtures thereof.
   N. The method according to L, wherein the foaming resin is a polyurethane reaction mixture prepared by mixing an isocyanate component and an isocyanate reactive component, wherein at least a portion of the abrasive particles are dispersed in the isocyanate reactive component before mixing it with the isocyanate component.
   O. The method according to L, wherein the foaming resin is prepared by mixing an isocyanate component and an isocyanate reactive component, wherein the isocyanate reactive component comprises isocyanate reactive compounds comprising, per 100 parts by the total weight of the foaming resin and the abrasive particles,
a) 50 to 200 parts of one or more polyetherpolyols with the OH number 48 mg of KOH/g and an average functionality of 1.5 to 4;
b) 0.2 to 10 parts of an amine catalyst;
c) 0.01 to 2 parts of a tin catalyst; and
d) 0.1 to 5 parts of a silicone surfactant.
   P. A method of cleaning a dish surface comprising soil on the dish surface, the method comprising:
a) wetting a sponge according to A with water;
b) applying liquid dishwashing detergent to the sponge; and
c) moving the sponge on the dish surface to remove the soil.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A sponge for cleaning dish surfaces, the sponge comprising:
a foam selected from the group consisting of: polyurethane foam, cellulose foam, polyvinyl alcohol (PVA) foam; and
abrasive particles disposed within the foam in an amount of from about 0.1% to about 30% by weight of the sponge, wherein the abrasive particles are solid and comprise a mean solidity from about 0.4 to about 0.75.

2. The sponge according to claim 1, wherein the abrasive particles comprise a material selected from the group consisting of: polyethylene, polypropylene, PVC, polycarbonate, melamine, urea, polyurethane, polyacrylate, polystyrene, phenolic, polyesters, polyamide, cellulosic polymers, polyhydroxyalkanoate, polylactic, polybutylenesuccinate, polycaprolactone, minerals and mixtures thereof.

3. The sponge according to claim 1, wherein the foam comprises a pore size from about 200 μm to about 5000 μm and the abrasive particles comprise a mean Equivalent Circle Diameter (ECD) from about 10 μm to about 1000 μm.

4. The sponge according to claim 1, wherein a circularity of the abrasive particles is from about 0.1 to 0.6.

5. The sponge according to claim 1, wherein the abrasive particles have a mean Shore® D hardness between 40 and 90.

6. The sponge according to claim 1, wherein a material of the abrasive particles are made from a foamed polyurethane material comprising a density of from about 25 kg/m³ to about 120 kg/m³ and a compressive strength of from greater than or equal to 80 kPa (0.8 kg/cm²) to less than or equal to 300 kPa (3 kg/cm²) with 10% deformation measured according to EN 826.

7. The sponge according to claim 1, wherein each of the abrasive particles are made from extruded fibers and comprise extruded protrusions having a longitudinal length (L) extending parallel to an extrusion axis of the extruded fibers and defining a cross-section of the abrasive particle perpendicular to the extrusion axis.

8. The sponge according to claim 7, wherein the cross-section of the abrasive particle comprises a mean solidity from about 0.4 to about 0.75, and wherein the ratio of said length (L) to an ECD of the cross section of the abrasive particle is from about 0.5 to about 3.

9. The sponge according to claim 1, wherein the abrasive particles are distributed throughout the foam.

10. The sponge according to claim 1, wherein the abrasive particles are dispersed adjacent an outer surface of the foam.

11. A composite sponge for cleaning dish surfaces, the composite sponge comprising:
a first layer comprising a sponge according to claim 1; and
a second foam layer bonded to the first layer.

12. A method of manufacturing a sponge for cleaning dish surfaces, the method comprising:
mixing abrasive particles in a foaming resin in an amount from about 0.1% to about 30% by the total weight of the foaming resin and the abrasive particles at a temperature of between about 10° C. and about 150° C. degrees C. for a time period of between about 0.5 minutes and about 60 minutes;
allowing the foaming resin comprising the abrasive particles to rise to form a sponge comprising a foam selected from the group consisting of: polyurethane foam, cellulose foam, polyvinyl alcohol (PVA) foam; and
curing the foam for a time period of between about 0.5 and about 48 hours at a temperature between about 10° C. and about 50° C. to form the sponge; wherein the abrasive particles are solid and comprise a mean solidity from about 0.4 to about 0.75.

13. The method according to claim 12, wherein the abrasive particles comprise a material selected from the group consisting of: polyethylene, polypropylene, PVC, polycarbonate, melamine, urea, polyurethane, polyacrylate, polystyrene, phenolic, polyesters, polyamide, cellulosic polymers, polyhydroxyalkanoate, polylactic, polybutylenesuccinate, polycaprolactone, minerals and mixtures thereof.

14. The method according to claim 12, wherein the foaming resin is a polyurethane reaction mixture prepared by mixing an isocyanate component and an isocyanate reactive component, wherein at least a portion of the abrasive particles are dispersed in the isocyanate reactive component before mixing it with the isocyanate component.

15. The method according to claim 12, wherein the foaming resin is prepared by mixing an isocyanate component and an isocyanate reactive component, wherein the isocyanate reactive component comprises isocyanate reactive compounds comprising, per 100 parts by the total weight of the foaming resin and the abrasive particles,
a) 50 to 200 parts of one or more polyetherpolyols with the OH number 48 mg of KOH/g and an average functionality of 1.5 to 4;
b) 0.2 to 10 parts of an amine catalyst;
c) 0.01 to 2 parts of a tin catalyst; and
d) 0.1 to 5 parts of a silicone surfactant.

16. A method of cleaning a dish surface comprising soil on the dish surface, the method comprising:
a) wetting a sponge according to claim 1 with water;
b) applying liquid dishwashing detergent to the sponge; and
c) moving the sponge on the dish surface to remove the soil.
